(19) United States
(12) Patent Application Publication
(10) Pub. No.: US 2012/0236980 A1
(43) Pub. Date: Sep. 20, 2012

(54) NUCLEAR POWER STATION

(75) Inventor: Oliver REDSCHLAG, Hannover (DE)

(73) Assignee: REDSCHLAG HOLDING GmbH, Hannover (DE)

(21) Appl. No.: 13/423,948

(22) Filed: Mar. 19, 2012

(30) Foreign Application Priority Data
Mar. 18, 2011 (DE) 10 2011 014 486.2

(51) Int. Cl. G21C 9/00

(52) U.S. Cl. 376/298

(57) ABSTRACT

A nuclear power station has a containment in which a reactor core is accommodated. According to the invention, an external cooling system for cooling the containment in the event of an accident is associated with the containment. The cooling system in particular has a coolant reservoir that is configured as a lake or is lake-like, and in which the containment is in contact with a coolant or may be brought into contact with a coolant, in particular a liquid coolant, in the event of an accident.

### CROSS-REFERENCE TO RELATED APPLICATIONS

This application claims the priority of German application no. 10 2011 014 486.2, filed Mar. 18, 2011, and which is incorporated herein by reference.

### FIELD OF THE INVENTION

The invention relates to a nuclear power station. More particularly, the invention relates to a nuclear power station an internal containment in which a reactor core is accommodated, and an external cooling system configured for cooling the containment in the event of an accident is operatively associated with the containment.

### BACKGROUND OF THE INVENTION

Such nuclear power stations are generally known, and have an internal containment (reactor pressure vessel) in which a reactor core is accommodated. During operation of known nuclear power stations, heat is generated by controlled nuclear fission and converted into electrical power.

For maintaining operational safety, it is essential to continuously ensure adequate cooling of the reactor core. For this purpose, electrically operated circulation pumps having multiple redundancy of the power supply are provided. If the cooling of a nuclear power station fails, for example due to damage to the circulation pumps or an interruption in the power supply, the reactor core heats to an excessive degree. This may cause cooling water present within the containment, i.e., reactor pressure vessel, to evaporate, thus increasing the pressure in the containment. To avoid damage to the containment in such a case, it may be necessary to discharge steam to the ambient air, thus emitting radioactivity into the atmosphere. Further heating of the reactor core may result in a partial or complete core meltdown, in which the fuel elements melt. To prevent infiltration of radioactive material into the earth during a core meltdown, it is known to allocate a so-called “core catcher” to the containment.

A core meltdown entails in particular the risk of damage to the containment, and thus, emission of radioactive material into the atmosphere. In particular, there is the risk that large quantities of radioactive material are discharged into the atmosphere during an explosion. Previous accidents have demonstrated that this involves risks for humans and the environment that are difficult to predict.

Nuclear power stations of this type are known, for example, from US 2010/0260302 A1, DE 4032046 A1, and DE 3615568 A1. From US 2010/0260302 A1 it is known, for example, to externally cool the containment in the event of an accident. In addition to an internal cooling system which provides for cooling of the fuel elements inside the containment, an external cooling system is provided by means of which the containment may be externally cooled in the accident situation. It is provided that the cooling system has a coolant reservoir that is configured as a lake or lake-like, in which the containment is or may be brought into contact with a coolant, in particular a liquid coolant, in the event of an accident.

The external cooling system is a stationary or fixedly installed cooling system whose configuration is selectable within a wide range, depending on the particular requirements.

### OBJECTS AND SUMMARY OF THE INVENTION

An object of the invention is to increase the safety of a nuclear power station in the event of an accident.

This object is achieved by the invention set forth herein.

The basic concept of the invention is that the containment is situated in a reservoir, and that a way or system is provided for flooding the reservoir in the event of an accident. In normal, i.e., undisturbed, operation of the nuclear power station, the reservoir is initially free of coolant. When an accident occurs, according to the invention the reservoir is flooded with coolant, so that cooling of the containment is achieved in the described manner. In this way, heating of the reactor core may be avoided in the event of a breakdown of the internal cooling system, for example due to damage to the circulation pumps, or due to a power interruption.

The containment in the reservoir may be at least partially, preferably essentially completely, covered by a coolant, in particular a liquid coolant, in the event of an accident. On the one hand, effective cooling of the containment is thus ensured. The cooling may be further improved by providing the reservoir with an inlet, and optionally with an outlet, in order to discharge heated coolant from the reservoir and to supply the reservoir with unheated coolant. On the other hand, accommodation of the containment in a reservoir has the advantage that discharge of radioactive materials to the reservoir is limited to a localized area if the containment is damaged. This reduces the harmful effects of the emitted radioactive material on humans and the environment in the event of an accident.

According to the invention, the reservoir may be situated above ground and configured in the manner of a trough. According to the invention, the containment and optionally other components and installations of the nuclear power station may be situated in the reservoir. In particular, the outer concrete casing of the nuclear power station may be situated in the reservoir.

In this regard, one advantageous further embodiment provides that at least the base of the reservoir is situated below ground level. For a reservoir situated above ground, it may be necessary to pump the coolant with vertical lift in order to flood the reservoir; in the present embodiment, however, pumping with vertical lift is not necessary when an appropriate inlet opening for the coolant is provided. Instead, during flooding of the reservoir the coolant flows into the reservoir under gravitational force.

Another advantageous further embodiment of the invention provides that the reservoir is situated in a cavern. In this embodiment, the reservoir and the containment and the reservoir [sic] are situated underground, thus further reducing the risk of discharge of radioactive materials into the atmosphere.

Another configuration of the embodiment of the reservoir provides that by way of a lowering device, in the event of an accident at least the containment is lowerable from an operating position into an accident position in which the containment is situated in the reservoir and at least partially covered by coolant. In this embodiment the lowering device, for example and in particular, may operate based on gravitational force, so that the lowering of the containment from the operating position into the accident position takes place due to the weight force of the containment and optionally other components and installations of the nuclear power station.

Another advantageous further embodiment of the invention provides that the depth of the reservoir is dimensioned in such a way that the containment is completely or almost completely covered by coolant in the event of an accident. In this embodiment, on the one hand effective cooling of the containment is achieved. On the other hand, the risk of discharge of radioactive materials into the atmosphere is reduced.

Depending on the particular requirements, a reservoir used according to the invention may have a single-shell or multi-shell configuration, and may be made of any given suitable material, for example concrete. In the case of a multi-shell configuration, monitoring spaces may be formed between the shells and monitored for inflow of coolant, using suitable sensors.

According to the invention, it is also possible to oscillatingly support the reservoir, and thus in a manner which is safe from earthquakes, as is generally known for supporting buildings for earthquake protection. For a multi-shell configuration of the reservoir, according to the invention it is also possible to oscillatingly support only one of the shells.

Depending on the particular requirements, the reservoir may be open at the top. However, it may also be provided with a cover, i.e., a roof or a superstructure.

The invention further includes a nuclear power station which includes an internal containment in which a reactor core is Accommodated, and an external cooling system configured for cooling the containment in the event of an accident operatively associated with the containment. The cooling system includes a coolant reservoir configured as a lake. The containment is configured for being brought into contact with a coolant from the cooling system, in the event of an accident; and, the containment is located in the coolant reservoir, and the containment is operatively associated with the coolant reservoir for being flooded by the coolant reservoir in the event of an accident.

A method according to the invention for cooling a containment of a nuclear power station in the event of an accident includes providing a coolant reservoir using a coolant, and situating the containment in the coolant reservoir. Further, there is cooling the containment in the coolant reservoir in an accident situation using a coolant, and flooding the coolant reservoir in which the containment is situated in the event of an accident.

Advantageous and useful further embodiments of the method according to the invention include that in the event of an accident, the containment is lowered from an operating position into an accident position in which the containment is situated in the reservoir and the containment is at least partially covered by coolant.

The invention is illustrated in the embodiments of a nuclear power station according to the invention, and is explained in greater detail below with reference to the accompanying highly schematic drawings. All features described, illustrated in the drawings, and claimed in the patent claims constitute the subject matter of the invention, alone or in any given combination, independently of their combination in the patent claims or their dependencies, and independently of their description or illustration in the drawings.

Relative terms such as up, down, left, and right are for convenience only and are not intended to be limiting.

### BRIEF DESCRIPTION OF THE DRAWINGS

FIG. 1 shows a highly schematic sectional view of a first embodiment of a nuclear power station according to the invention; and

FIG. 2 shows, in the same manner as FIG. 1, a second embodiment of a nuclear power station according to the invention.

### DETAILED DESCRIPTION OF THE INVENTION

Identical or corresponding components are provided with the same reference numerals in the figures of the drawing.

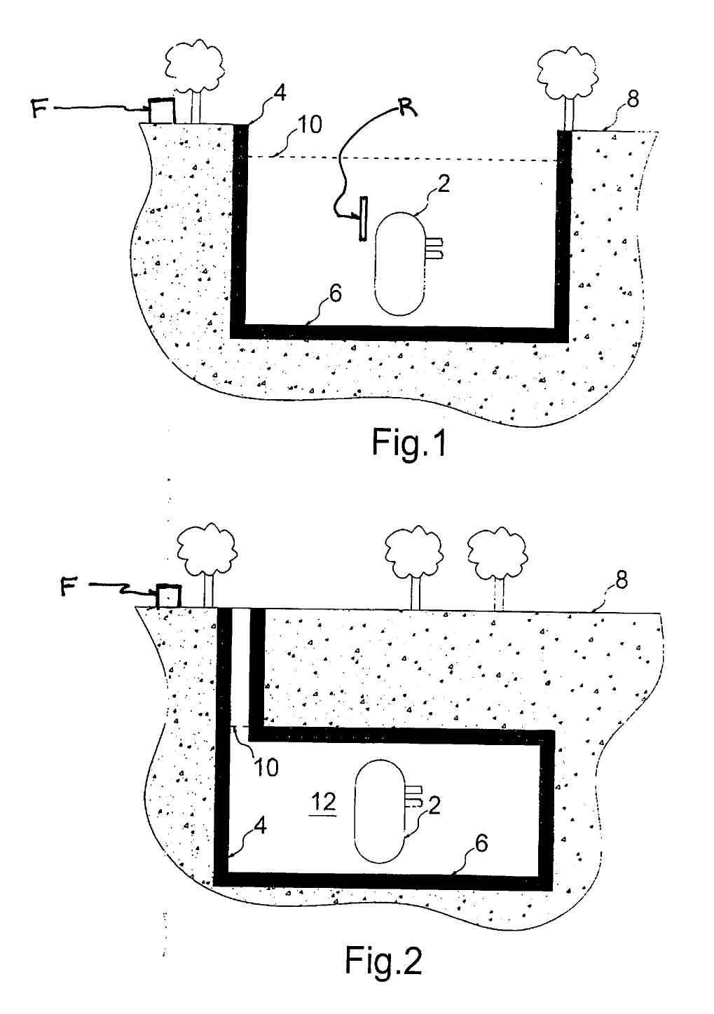

FIG. 1 illustrates one embodiment of a nuclear power station according to the invention; for the sake of clarity, only an internal containment 2 (reactor pressure vessel) accommodating a reactor core is shown. The basic mode of operation of a nuclear power station as well as the components and installations necessary for same are generally known, and therefore are not explained in greater detail herein.

An external cooling system for cooling the containment 2 in the event of an accident is allocated to containment 2. In the illustrated embodiment, the external cooling system includes a coolant reservoir, configured as a lake 4, which accommodates the containment 2 and which is or may be brought into contact with a coolant, in particular a liquid coolant, in the event of an accident. In the illustrated embodiment the lake 4 is embedded in the earth, so that the base 6 of the lake 4 is below ground level 8. The side walls of the lake 4 terminate approximately at ground level. The external cooling system provided according to the invention also includes a device F for flooding lake 4 in the event of an accident, and which is operatively associated with the coolant reservoir, as will be readily appreciated.

When an accident occurs, lake 4 is flooded with a liquid coolant with the aid of flooding device F, so that in the illustrated embodiment the containment 2 is completely covered by coolant. The level of coolant in the lake 4 after flooding the same is indicated by a dashed line 10 in FIG. 1. As a result of the containment 2 being completely surrounded by coolant and covered by the same, effective cooling of the containment 2 is achieved after the lake 4 is flooded, so that overheating of the reactor core together with the resulting consequences may be avoided or at least delayed. In addition, as a result of the containment 2 being covered by the coolant, the risk that fairly large quantities of radioactive materials are discharged into the atmosphere is reduced.

A device R may be provided for lowering the containment from an operating position into an accident position in which the containment is situated in the reservoir and the containment is at least partially covered by coolant, in the case of an accident.

FIG. 2 illustrates a second embodiment of a nuclear power station according to the invention, which differs from the embodiment according to FIG. 1 in that the lake 4, and therefore also the containment 2, is situated in a cavern 12.

While this invention has been described as having a preferred design, it is understood that it is capable of further modifications, and uses and/or adaptations of the invention and following in general the principle of the invention and including such departures from the present disclosure as come within the known or customary practice in the art to which the invention pertains, and as may be applied to the central features hereinbefore set forth, and fall within the scope of the invention.

What is claimed is:

1. Nuclear power station, comprising:
a) an internal containment in which a reactor core is accommodated;
b) an external cooling system configured for cooling the containment in the event of an accident is operatively associated with the containment;
c) the cooling system includes a coolant reservoir configured as a lake;
d) the containment is configured for being brought into contact with a coolant from the cooling system, in the event of an accident;
e) the containment being located in the coolant reservoir; and
f) a device being provided for flooding the containment, and the flooding device being operatively associated with the coolant reservoir for flooding the coolant reservoir in the event of an accident.

2. Nuclear power station according to claim 1, wherein:
a) a base of the reservoir is situated below ground level.

3. Nuclear power station according to claim 2, wherein:
a) the reservoir is situated in a cavern.

4. Nuclear power station according to claim 1, wherein: the reservoir is situated in a cavern.

5. Nuclear power station according to claim 1, wherein:
a) the reservoir is configured for being lowerable by a lowering device, in the event of an accident, from an operating position into an accident position in which the containment is situated in the reservoir and at least partially covered by coolant in the coolant reservoir.

6. Nuclear power station according to claim 5, wherein:
a) the reservoir has a depth, and the reservoir is dimensioned so that the containment is one of completely and substantially completely covered by coolant in the event of an accident.

7. Nuclear power station according to claim 1, wherein:
a) the reservoir has a depth, and the reservoir is dimensioned so that the containment is one of completely and substantially completely covered by coolant in the event of an accident.

8. Method for cooling a containment of a nuclear power station in the event of an accident, the method comprising:
a) providing a coolant reservoir using a coolant;
b) situating the containment in the coolant reservoir;
c) cooling the containment in the coolant reservoir in an accident situation using a coolant; and
d) flooding the coolant reservoir in which the containment is situated in the event of an accident.

9. Method according to claim 8, wherein:
a) in the event of an accident, the containment is lowered from an operating position into an accident position in which the containment is situated in the reservoir and the containment is at least partially covered by coolant.
